(19) United States
(12) Patent Application Publication
(10) Pub. No.: US 2002/0026386 A1
(43) Pub. Date: Feb. 28, 2002

(54) Personalized storage folder & associated site-within-a-site web site

(76) Inventor: John C. Walden, Edina, MN (US)

Correspondence Address: Stephanie J. Smith, Beck & Tysver, P.L.L.C., Suite 100, 2900 Thomas Avenue S., Minneapolis, MN, 55416, US

(21) Appl. No.: 09/880,485

(22) Filed: Jun. 13, 2001

Related U.S. Application Data
(60) Provisional application No. 60/225,918, filed on Aug. 17, 2000.
(60) Provisional application No. 60/277,886, filed on Mar. 22, 2001.

(51) Int. Cl. G06F 17/60

(52) U.S. Cl. 705/27

(57) ABSTRACT

A personalized site-within-a-site feature of a web site is presented that allows users to select items for placement in a personalized storage space. The items stored in this storage space are automatically categorized in a hierarchical system of categories and subcategories. Items within a category or subcategory can be compared to other selected products in the same category or subcategory, or a detailed information page about the product can be presented. The functionality of the whole site, including the item hierarchy, item detail pages, and item comparisons, is available for the user to apply to the items selected by the user. This functionality can be utilized without leaving the site-within-a-site feature. A visual indicator is present on each web page forming part of the site-within-a-site.

Once items are placed in the site-within-a-site, the user can be presented with updated information on the items on subsequent visits. Prices for the items can be automatically updated to reflect current sales and promotions. Items that have recently been added to the site can be compared to the items found in the users' site-within-a-site. If a new item closely matches the features of a selected item, the user can be informed of the availability of the new item. In addition, promotions can be directed at the user of the site-within-a-site based upon the items in their storage space and subcategories containing those items.

This application claims priority to application Ser. No. 60/225,918 filed on Aug. 17, 2000 and application Ser. No. 60/277,886 filed on Mar. 22, 2001 under 35 U.S.C. §119(e).

### FIELD OF THE INVENTION

The present invention relates generally to a site-within-a-site feature in a commercial, retail web site. More particularly, the invention relates to a retail web site wherein items selected for further consideration by a user are added to a site-within-a-site, and wherein product information and comparison functions found in the main site function on only the selected items when the user is in the site-within-a-site.

### BACKGROUND OF THE INVENTION

A web site is generally considered to be a collection of web pages linked together through a navigational system that allows users to move from page to page. Web pages are linked together such that when a user clicks on a predefined “click space” or link on one web page, another web page appears. Click spaces or links are indicated by text, sometimes underlined, or by button-like graphics or other graphically-defined regions. Web pages in a web site are generally organized and accessed through a navigational tree, wherein pages are organized in a hierarchical or outlined fashion.

A number of web sites currently provide for a personalized web page in which information specific to a particular user is stored. For example, some stock brokerage web sites allow a user to establish a personalized page, in which the user can specify what content he or she wishes to have appear on the page. Each time the user enters the personalized page, the requested content is displayed. For example, the user can identify stocks of interest, and their personalized page will show a list of those stocks along with a current stock price. By clicking on the stock name, additional information regarding the selected stock is presented on a new page. However, once the user is shown the stock information page, the user is no longer within the personalized section of the web site. In other words, the page they are viewing with the detailed stock information is identical to the page they would have viewed if they had accessed this from the general site (i.e. not from their personalized page).

Most retail web sites offer a “shopping cart” in which a user can store a list of products that the user has selected for purchase. Items are added to the shopping cart simply by selecting an “add to cart” link from a product description page. The list of products in the shopping cart is saved for a given period, so that when the user returns to the web site at a later time, the selected products are still there and ready for purchase. When a user places items in the cart, the items are stored as a list. Clicking on an item in the list takes the user back to the same product page that was available to the user from the main site. In other words, anytime the user leaves the shopping cart, the user returns to the main navigation stream of the web site.

In addition to the shopping cart, some retail web sites have a “wish list” feature, in which users can add desired products. These lists function much like a shopping cart, in that products can be added and taken out of the wish list much like products are added to and taken out of a shopping cart. The difference is that wish list items are not to be purchased directly by the user. Rather, they serve as a place for individuals other than the user to view the items, and perhaps purchase the items as gifts for the user. Also, like shopping carts, if a user wishes to see detailed product information about items in the wish list, the web site returns the user to the main navigation stream of the web site.

Other retail web sites allow users to set up accounts and to define custom folders. The user then places products into the customer-defined folders. For example, the user might label one folder as “Monthly Supplies” and then put into the folder all of the supplies that need to be ordered on a monthly basis. Another folder might be labeled “New Employees,” and could be used for all of the supplies that need to be ordered when the company hires a new employee. The site then offers a convenient method of ordering of all of the items within a custom folder. This saves the user the hassle of re-selecting products that are ordered on a recurring basis. When a user seeks to see detailed information about a product in a shopping list, the user is routed out of the shopping list navigation back into the main stream of the web site.

Thus, many web sites have individualized areas in which users can store a list of selected items. Unfortunately, the individualized areas are left behind whenever detailed information is desired about an item. In addition, if a comparison function is built into the web site, the comparison is not made an element of the individualized area. Rather, the user must leave the individualized pages and select the comparison function and the items to compare in the regular navigation stream of the web site. There is no direct mechanism for comparing items that were selected by the user during an earlier session.

What has been needed is a personalized site-within-a-site in which a user can place items under consideration for future purchase. When interacting with the site-within-a-site, the user can view product detail information and do product comparisons without getting routed back into the main navigation stream of a site. This is of particular import for higher-priced items that require a longer and more involved decision-making process. A purchaser of these items may need to revisit their product data a number of times before being ready to make their final purchasing decision. Further, what has been needed is a way for the user to easily compare the items in which they have already expressed an interest. Still further, what has been needed is a way for a user to browse through detailed description pages for each stored item without having to repeatedly perform searches or navigate to desired items.

### SUMMARY OF THE INVENTION

The present invention meets these needs by providing a personalized site-within-a-site feature. This feature offers the full functionality and access to information that is available through the main portion of a web site, but applies such functionality and access only to the items that the user has added to the site-within-a-site. The user is not overwhelmed with the entire universe of available items when the user has already narrowed their search down to a relatively few number of items. These items are then stored for multiple visits, allowing a user to make a well-researched buying decision over multiple visits to the web site.

According to one aspect of the invention, personalized storage space is provided in which a user can store products that are to be subject to further consideration. This storage space constitutes a site-within-a-site. The products stored in this storage space are automatically categorized in a hierarchical system of categories and subcategories. Products within a category or subcategory can be compared to other selected products in the same category or subcategory, or a detailed information page about the product can be presented. Whether a comparison is made or an information page is selected, the user does not leave the site-within-a-site.

Once items are placed in the site-within-a-site, the user can be presented with updated information on the items on subsequent visits. Prices for the items can be automatically updated to reflect current sales and promotions. Items that have recently been added to the site can be compared to the items found in the users' site-within-a-site. If a new item closely matches the features of a selected item, the user can be informed of the availability of the new item.

According to another aspect of the invention, a personalized site-within-a-site allows a user to store topics of interest and to access up-to-date information on those stored topics while navigating out of the personalized site.

### BRIEF DESCRIPTION OF THE DRAWINGS

An exemplary version of a personalize item-under-construction site-within-a-site is shown in the figures wherein like reference numerals refer to equivalent structure throughout, and wherein:

FIG. 1 is a schematic illustration of the navigational flow in a web site having a items-under-consideration area;

FIGS. 2a-c are schematic illustrations of web pages in a main site having links to an items-under-consideration site within the main site;

FIGS. 3a-c are schematic illustrations of pages within an items-under-consideration site within a main site;

FIGS. 4a-d are web pages in an example of a main site having links to enter an items-under-consideration site (“ThinkAbout(tm) folder”);

FIG. 5 is an example of a web page for signing into a personalized item-under-consideration site;

FIG. 6 is an example of a web page for welcoming a user to their personalized item-under-consideration site and showing an index of items within a category (e.g. “DVD players”, “Portable MP3”), with categories grouped by major category (e.g.“Home Audio & Video”, “Personal Audio”, “Computers & Peripherals”), in the item-under-consideration site;

FIG. 7 is an example of a web page showing an overview of products within a category (“Televisions”), grouped by subcategory (e.g. “Small TVs 5″-20″, “TV/VCR Combos”);

FIG. 8 is an example of a web page showing a product comparison of items within a subcategory;

FIG. 9 is an example of a web page within the items-under-consideration site showing product detail content; and

FIG. 10 is a table illustrating a database supporting personalized folders in a retail web site.

### DETAILED DESCRIPTION OF PREFERRED EMBODIMENT(S)

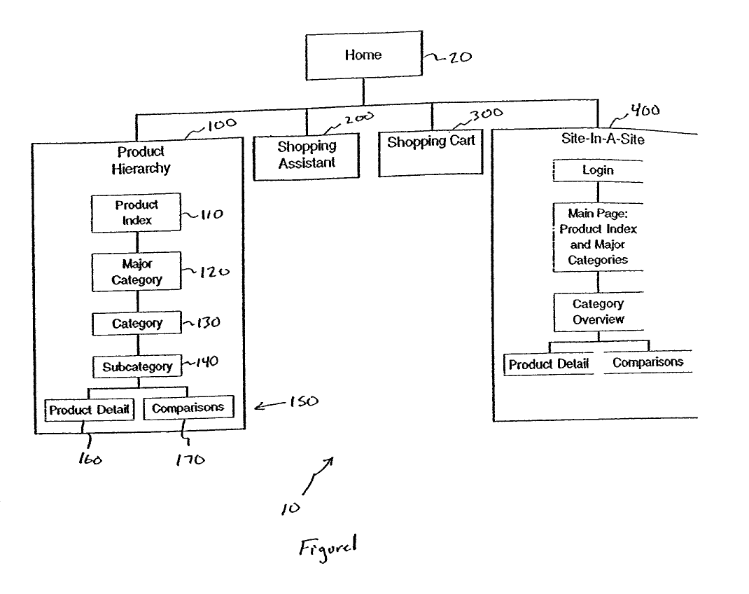

The present invention relates to a web site 10, such as that shown in the hierarchical representation shown in FIG. 1. More specifically, the present invention web site 10 allows users to review a variety of items 12 (not shown in FIG. 1), generally for the ultimate purpose of purchasing or otherwise acquiring such items 12. In a retail web site 10 using the present invention, such items 12 would constitute products for sale through the web site 10. In a brokerage situation, the items 12 presented by the web site 10 might comprise stocks, bonds, or mutual funds.

For a web site 10 used for promoting various services, the items 12 would constitute the services being offered. Thus, the items 12 being reviewed in the present invention could represent numerous real-world items or services. For the purposes of this description, the present invention will be described below in connection with a retail web site selling electronics products.

Referring again to FIG. 1, the user of the web site 10 can access a variety of services through a home page 20. For instance, the user may access product information using a product hierarchy 100 or a shopping assistant 200. Once items 12 are selected for purchase, they are placed in a shopping cart 300 from which the purchase can be completed. The present invention also includes a site-within-a-site feature or service 400 that constitutes the present invention. The site-within-a-site feature 400 allows people to save items 12 for further evaluation. In the Figures, the term “site-within-a-site” is shortened to “site-in-a-site.”

The product hierarchy 100 is divided into various levels, including product index 110, major category 120, category 130 (also referred to as “minor category” 130), subcategory 140, and product specific level 150. The user can access information about the products available on the web site 10 by navigating up and down this product hierarchy 100. The product specific level 150 of the hierarchy 100 allows products to be examined either one at a time on a product detail page 160, or by selecting products for comparison in a product comparison page 170.

The shopping assistant service 200 allows the user to select products by answering questions about desired product features. The shopping cart service 300 allows users to place products that they desire in a virtual shopping cart 300. When the user desires to purchase these items 12, they “check out” the items 12 and specify payment and delivery options. The shopping assistant service 200 and the shopping cart service 300 are not directly relevant to the present invention, and therefore are not discussed in detail in this application.

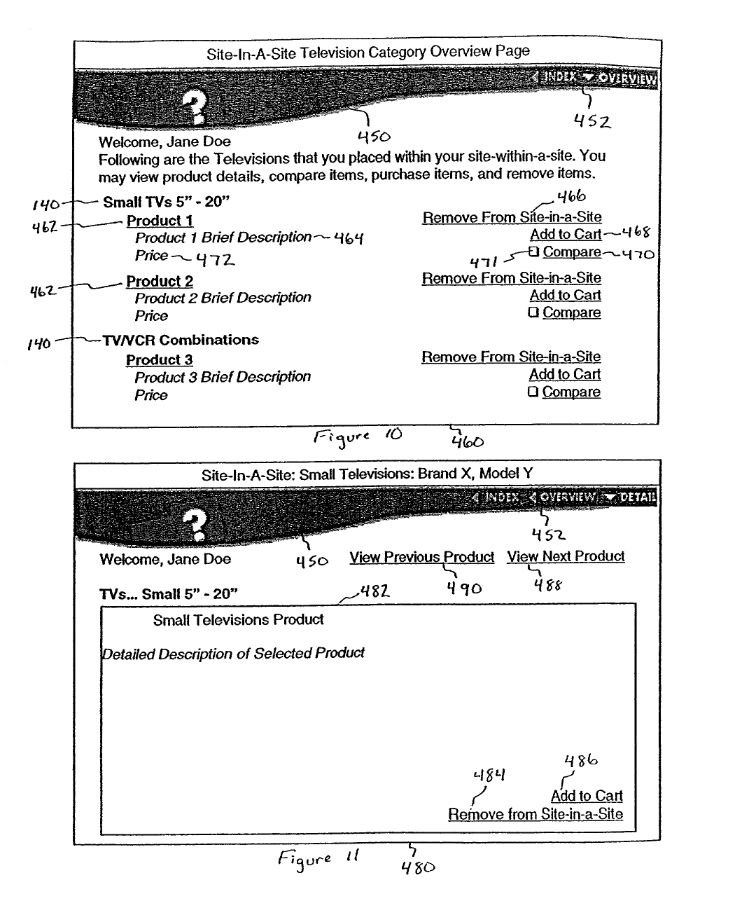

The site-within-a-site feature 400 forms the heart of the present invention. This feature is described in detail below in connection with FIGS. 8 though 13.

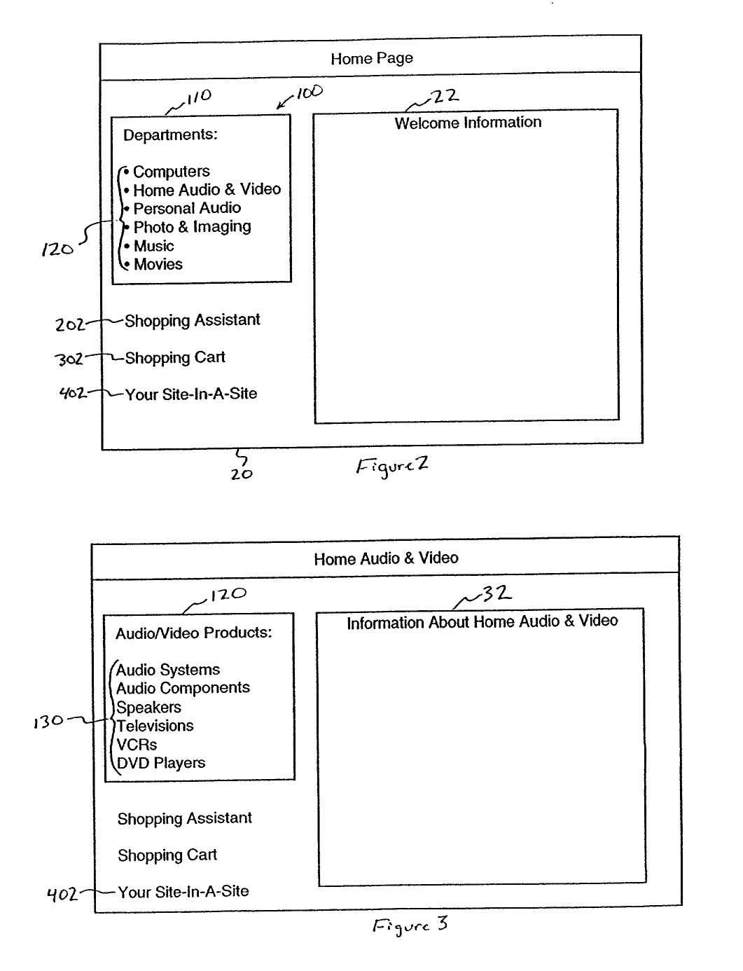

Each of these services and features can be accessed through the home page 20, an example of which is shown in FIG. 2. The product hierarchy 100 is usually entered through a product index 110 found on the home page 20. The product index, labeled “Departments” on FIG. 2, lists the major categories 120 of products that are available on the web site 10. Likewise, the shopping assistant 200, the shopping cart 300, and the site-in-a-site 400 services can be directly accessed through links on the home page 20 through links 202, 302, and 402, respectively. The home page 20 will also likely include welcome information 22 that welcomes users and describes the web site 10.

When a major category 120 is selected from the product index 110, a major category page 30 is presented to the user that lists the categories 130 in the selected major category 120. FIG. 3 shows a major category page 30 for the Home Audio and Video major category 120. The major category page 30 will then show the categories (minor categories) 130 of products that are found within the selected major category 120. Categories 130 shown in FIG. 3 for the Home Audio and Video major category 120 include “Televisions,” “DVD Players,” and “VCRs.” The major category page 30 also generally includes some information 32 about the major category 120 selected.

A user can select a desired category 130 from the list of categories presented on a major category page 30. When selected, a category page 40 is displayed that lists the subcategories 140 of products available for that category 130. FIG. 4 shows a category page 40 for the “Television” category. Category pages 40 generally include a description 42 of the selected category, and may include promotional information concerning items 12 in that category.

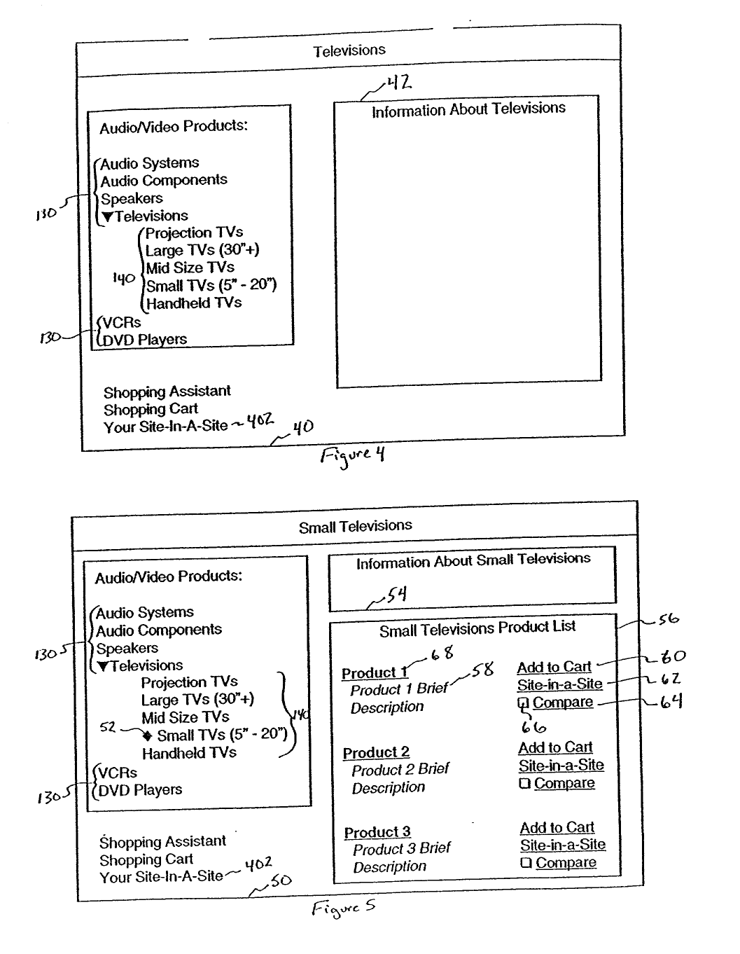

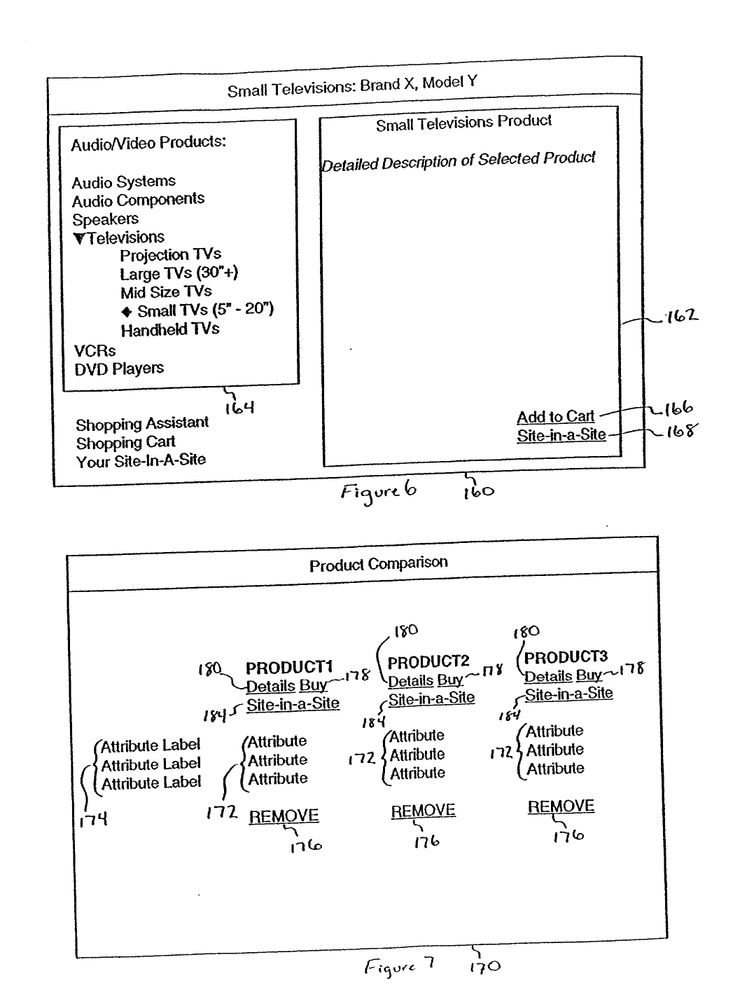

Upon selection of one of the subcategories 140 on a category page 40, a subcategory page 50 is displayed, such as the Small TV subcategory page 50 shown in FIG. 5. Rather than removing the list of categories 130 and subcategories 140 generated in the category page 40, the subcategory page 50 maintains that list and simply places a selection marker 52 next to the selected subcategory 140. The subcategory page 50 contains information 54 about the selected subcategory, as well as a list 56 of the individual products that are found in that subcategory 140.

Each product entry in the product list 56 includes a brief product description 58, as well as links to add the item to the shopping cart 300 (link 60), to add the item to the site-in-a-site feature 400 (link 62), or to perform a product comparison (link 64). Next to the comparison links 64 are selection boxes 66 that allow a user to select the items 12 that the user wishes to compare before following the comparison link 64.

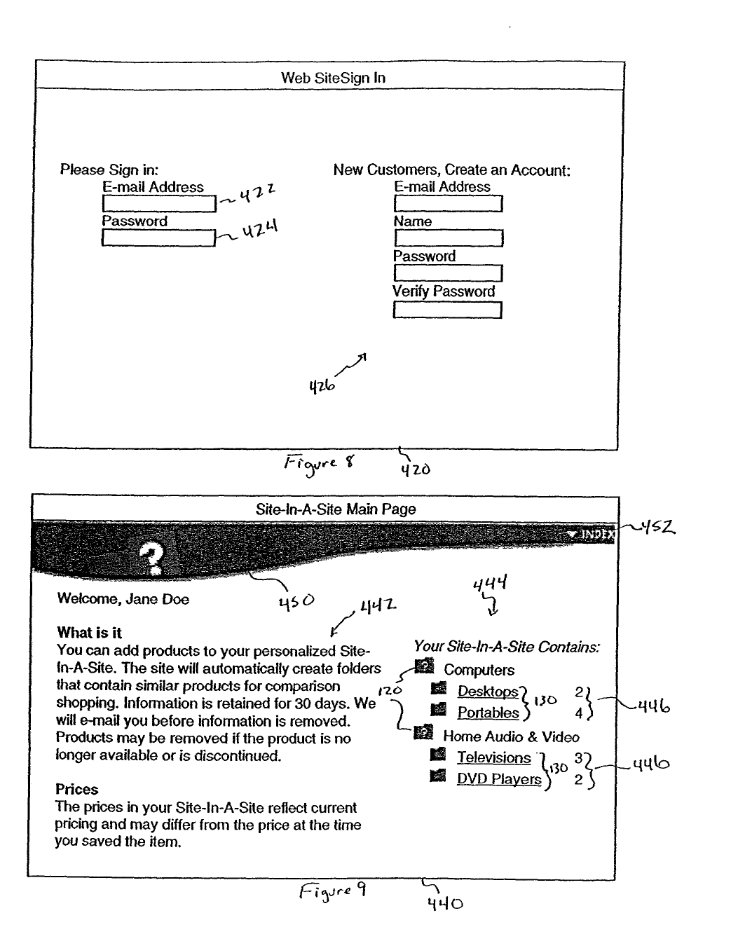

The title 68 of the items 12 in product list 56 constitutes a link that, if followed, opens up a product detail page 160 regarding the product, such as that shown in FIG. 6. The product detail page 160 will contain detailed information 162 about the selected product. Within the product detail page 160, a partial view 164 of the product hierarchy 100 is preferably displayed so that a user can easily find similar products for review. A link 166 for adding the described item to the shopping cart 300 and a link 168 for adding the item to the site-in-a-site feature 400 are also included on the product detail page 160.

The present web site 10 further includes a product comparison page 170, through which a user can perform a side-by-side comparison of selected products, as shown in FIG. 7. As described above in connection with subcategory page 50, the product list 56 includes selection boxes 66 by which the user can identify those products to be compared. The product comparison page 170 displays selected products in a chart-like format, with pre-defined product attributes 172 listed for each selected product. Product attributes 172 are listed under the name of the product, with attribute labels 174 in the left-most column. Preferably, the product comparison page 170 offers click spaces 176 associated with each product to remove a product from the comparison. In addition, the comparison page 170 offers the user the opportunity to select a product for purchase by clicking on the designated purchase click space 178. In addition, the product comparison page 160 includes links 180 for accessing the product detail page 160 for the selected product. Clicking on link 184 adds the product to the site-within-a-site feature 400.

As explained above in connection with FIG. 1, the web site 10 of the present invention includes a personalized site-within-a-site feature 400. This feature 400, allows a user to store one or more products for later evaluation. This personalized site-within-a-site feature 400 can be considered to contain a special, personalized storage folder 410 that is distinct from the shopping cart feature 300.

Preferably, the personalized storage folder 410 can be accessed from a number of portals in the main web site. For example, the home page 20 in FIG. 2 shows a link or click space 402 to get to the user's storage folder 410. Similar links 402 appear on the web pages shown in FIGS. 3 through 6.

Additionally, links appear throughout the web site 10 that allow the user to add particular items 12 to either the shopping cart feature 300 or to the personalized folder 410 of the site-within-a-site feature 400. This is seen in the subcategory page 50, which includes links 60 and 62 that add the item to the shopping cart feature 300 or the site-within-a-site feature 400, respectively. Similarly, links 166 and 168 serve the same function in the product detail page 160, while links 178 and 184 serve that function in the product comparison page 170. Thus, when the user wishes to save a particular item 12 for later review and evaluation, the appropriate link 62, 168, 182 associated with the item 12 is selected and the item 12 is added to the personalized folder 410 of the user. As the item 12 is added to the folder 410, the web site 10 automatically categorizes the selected item. Preferably, the categorization used by the web site 10 is hierarchical and matches the product hierarchy 100 used in the main or public portion of the web site 10.

To enter the site-within-a-site feature 400, the user clicks on an appropriate link 402 to enter the main site, or clicks on a link 62, 168, or 182 to add a product to the personalized storage folder 410. The first time the site-within-a-site feature 400 is accessed in a session, returning users are asked to enter their unique user name 422 and password 424 through a login screen 420, as shown in FIG. 8. If a user does not already have an account, the login screen gives the user the opportunity to set up an account at area 426. Later accesses to the site-within-a-site feature 400 in the same session generally to not require a login procedure. A session can be defined to be a set time period, such as one day after the last login or one hour after the last access to the web site 10. Alternatively, the web site 10 could use cookies so that the user is automatically identified on later visits. The same login procedure used for the site-within-a-site feature 400 can be used for all other login procedures for the entire web site 10, including the login used to access the shopping cart feature 300 or any other personalized aspects of the site 10.

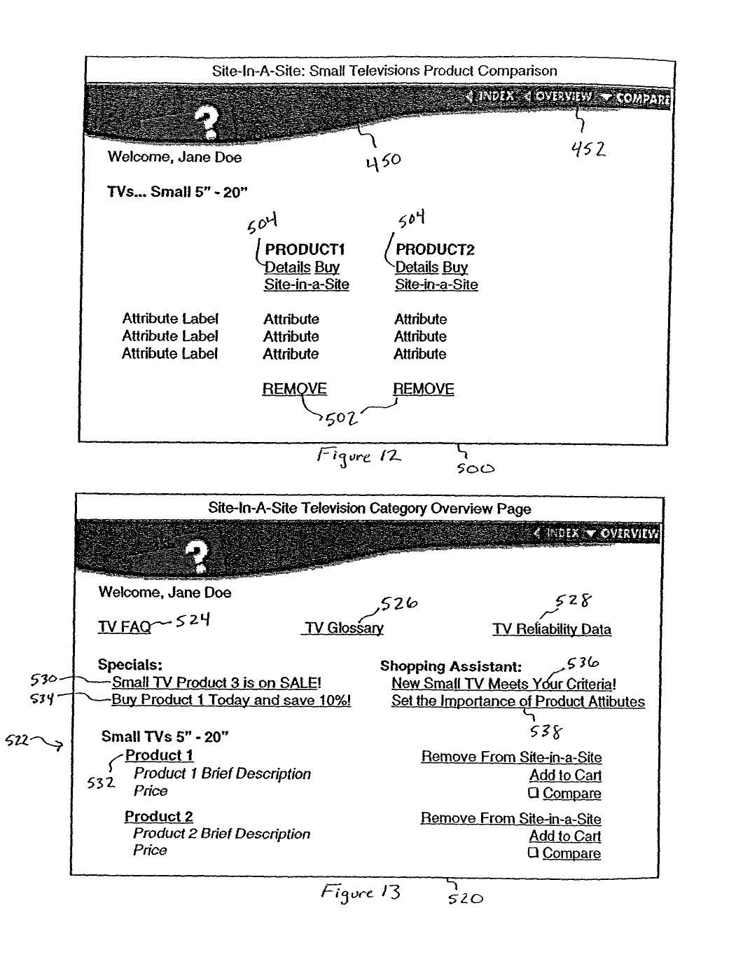

After logging in, the site-within-a-site feature 400 displays a main page 440, as shown in FIG. 9. In a preferred embodiment, the main page 440 includes a description 442 of the site-in-a-site feature 400, and a list 444 reflecting the products the user has previously selected for storage in their personalized storage folder 410. In the preferred embodiment, the individual products themselves are not listed on the main page 440. Instead, the main page 440 shows the major categories 120 into which the previously selected products were automatically placed, and the categories 130 within each major product category 120 in which products have been placed. Preferably, the main page 440 does not show empty major categories 120 or categories 130, i.e. areas of the hierarchy 100 for which the user has not stored any products. The product list 444 also includes a numeral 446 for each category 120 listed, which indicates the number of items 12 that the user has placed within that category. For the main page 440 shown in FIG. 9, the user has placed two desktop computers, four portable computers, three televisions, and two DVD players in their personalized folder 410.

The main page 440 of the site-within-a-site feature 400 also includes a site-within-a-site identification banner 450. This banner is used to indicate to the user that the current page being viewed is within the site-within-a-site feature 400, and not in the general product hierarchy 100. Although the preferred embodiment uses an identification banner 450 for this purpose, it would be well within the scope of the present invention to use any visual indicator for this purpose. The identification banner 450 also includes a map indicator 452 that indicates where the user is within the site-within-a-site feature 400, and allows the user to selectively enter different levels of the feature 400.

Although not shown in FIG. 9, it is also desirable to have links with the site-within-a-site feature 400 that allow the user to exit the feature 400. Such links might include a link back to the main product hierarchy 100 (or a major category 120 within the hierarchy 100), or a link to the shopping assistant feature 200 or the shopping cart feature 300. Preferably, the links would appear consistently on all pages within the site-within-a-site feature 400, and would be placed on the pages in a way to indicate to the users that the links will cause the user to leave the site-within-a-site 400.

To see an overview of the stored products within a category 130, the user clicks on or selects a category 130 listed in the main page 440. This action returns a linked category overview page 460, such as the television category overview page 460 shown in FIG. 10. This page 460 shows all of the products the user has selected within television category 130. The products are organized in outline form, with each selected product located within their correct subcategory 140. Preferably, the overview page 460 does not show any subcategories 140 that do not contain products selected for the site-within-a-site feature 400.

In the television category overview page 450, two subcategories 140 are shown for the television category 130, namely the Small TV subcategory 140 and the TV/VCR Combo subcategory 140. In FIG. 10, the user has placed two items 12 from Small TV subcategory 140 and one item 12 from the TV/VCR Combinations subcategory 140 into their personalized folder 410. Each of the items 12 listed in the category overview page 460 has a product identifier 462 and a brief description of the product 464. In addition, each item 12 has three links or click spaces that allow the user to remove the item 12 from the personalized folder 410 (link 466), to add the item 12 to the shopping cart feature 300 (link 468), or to compare the items 12 to each other (link 470). Finally, it may be useful to provide the user with a price 472 for each of the items listed on page 460.

It is important to note that the category overview page 460 includes an identification banner 450 similar or identical to the banner 450 found on the main page 440. As explained above, this banner 450 serves to clarify to the user that they are within the site-within-a-site feature 400 of the web site 10. Note that the map indicator 452 of the banner now indicates that the use is at the overview level of the hierarchy, and that the index or main page 440 can be accessed by simply clicking on the word “INDEX” in the map indicator 452.

Preferably, the category overview page contains links, associated with each product, for accessing a page of detailed information about the product. In FIG. 10, this link is provided by the product identifier 462 itself. When clicked, a product detail page 480 is presented to the user, such as that shown in FIG. 11. This site-within-a-site product detail page 480 is preferably similar to the product detail page 160 that is accessed through the product hierarchy 100 in the main or public portion of the web site. For instance, both pages 160 and 480 include a detailed description 162, 482 of the selected product, which can include both text and images. Both pages 140, 480 also offer a link 166, 486 that allows the user to add the selected product to the shopping cart feature 300. Both pages also allow the user to control whether the item 12 belongs within the site-within-a-site feature 400, with page 160 including a link 166 to add the product to the personalized folder 410, and with page 480 including a link 484 that removes the product from personalized folder 410.

One difference between these pages 160, 480 is that page 160 is shown with a partial view 164 of the product hierarchy 100 (as well as feature links 202, 302, and 402), while page 460 does not include such a view or links. However, it is well within the scope of the present invention to include access to the hierarchy 100 and feature links 202, 302, and 402, within the site-within-a-site feature 400. Of course, as mentioned previously, when such access is provided it should be clear to the user that following such links into the hierarchy 100 leads the user out of the site-within-a-site feature 400.

A more important distinction between the two pages is the inclusion in page 480 of the identification banner 450 and the navigation links 488, 490 that allows the user to move about within the site-within-a-site feature 400. As mentioned before, the identification banner 450 indicates to the user that they are within the site-within-a-site feature 400, and also includes a map indicator 452, which includes a detail level to indicate that the user is now viewing product detail. The overview and index portions of the map indicator 452 still exist, allowing the user to directly access the category overview page 460 and the main page 440 of the site-within-a-site feature 400.

In addition, link 488 allows the user to view the product detail page 480 for the next stored product within the same subcategory 140 as the current product. Another link 490 allows the user to navigate to the product detail page for the previous stored product within the same subcategory. These links allow the user to go easily between product detail pages 480 for those items 12 that the user chose to place in the personalized folder 410. This type of easy navigation between pre-selected detail pages on selected products was not previously obtainable in the prior art shopping cart and list technologies. In the preferred embodiment, the previous item link 490 would not appear on a product detail page 480 for the first item in a subcategory 140, and the next item link 488 would not appear on the page 480 for the last item 12 in a subcategory 140. The terms “next,” “previous,” “first,” and “last,” when used in connection with links 488 and 490, refer to the listed order of the products on the category overview page 460. That order is predetermined or, alternatively, is determined according to one or more sort criteria selected by the user. In a retail shopping site, desirable sorting criteria include price, alphabetical by product name, alphabetical by brand, or by order of selection by the user.

Preferred category overview page 460 contains links 470 and selection boxes 471 for allowing users to compare items 12 within the same subcategory 140 within the personalized folder 410. The click spaces 470 and check boxes 471 function similarly to the links 64 and boxes 66 found on subcategory page 50. Typically, by default, all the selection boxes 471 presented in category overview page 460 are pre-selected, so that a comparison of all items 12 within a subcategory 140 can be compared merely by selecting a comparison link 470 for an item 12 in that subcategory 140.

When such a comparison is done on items 12 in the site-within-a-site feature 400, a comparison page 500 is presented to the user, such as that shown in FIG. 12. This comparison page 500 is similar to the comparison page 170 shown in FIG. 7, in that a side-by-side comparison of features is presented for multiple products. Both pages 170, 500 also present a remove link 176, 502 that removes the product from the current comparison. Note that pressing the remove link 502 on the site-within-a-site comparison page 500 does not remove the item 12 from the customized folder 410, but merely removes it from the current comparison. Although, in the comparison page 500 illustrated in FIG. 12, there is no link that removes an item 12 from the customized folder 410 on comparison page 500, it would be well within the scope of the present invention to include such a link.

The main difference between the comparison page 170 of the product hierarchy 100 and the site-within-a-site comparison page 500 is the presence of the identification banner 450 and the map indicator 452 on the site-within-a-site comparison page 500. These elements 450, 452 serve to identify the current page 500 as a comparison page within the site-within-a-site feature 400, and also gives the user easy access to the category overview page 460 and the site-within-a-site main page 440. In addition, the details link 504 of the site-within-a-site comparison page 500 opens a product detail page 480 that keeps the user in the site-within-a-site feature 400.

The site-within-a-site feature 400 is ideally implemented in contexts where the user may require several visits to a web site 10 before making a purchase decision. Consequently, it is expected that changes will take place in the price and availability of items in a user's personalized folder 410 from one visit to another. In the preferred embodiment of the present invention, these changes will alter the items in the personalized folder 410 of all users of the web site. Thus, when a user accesses items 12 that were previously stored in their personalized folder 410, the price of the item 12 may have changed. If the item 12 is no longer available through the web site 10, the item 12 may be completely removed from the personalized folder 410. A notification of such removal may be given to the user when they access the main page 440 or the relevant category overview page 460.

In addition, to prevent the storage of information in the personalized folders 410 of users who no longer wish to keep such information, the preferred embodiment deletes items in personalized folders 410 that have not been accessed in a set period of time. By providing notice to users that their information is soon to be deleted, the web site 10 can prevent the deletion of information that users wish to keep. Such notice preferably instructs users to visit their personalized folder before the deletion date in order to reset the clock for deletion.

Since the items in the personalized folder 410 are automatically categorized when they are placed in the folder 410, the web site 10 has a great deal of information about the type of products that the user is currently considering. This information can be used to present the user with details about sale pricing and newly available items in the same subcategories 140 as the items 12 that the user has already selected. This customized information could be presented on a variation of the category overview page 460, such as the second embodiment page 520 shown in FIG. 13.

This second embodiment of the category overview page 520 includes the same information 522 that is found on page 460 concerning the items 12 in this category 130. In addition, the second embodiment page 520 contains general information for the user about the relevant category 130, such as a FAQ (frequently asked questions) 524, a glossary 526 of terms used by television manufacturers, and reliability data 528 of televisions offered in the web site 10.

More importantly, this embodiment 520 contains links to products and specials that have been specially generated for this user based upon the contents of the user's personalized folder 410. For instance, a first special offer 530 could be presented to the user concerning an item not currently in the user's personalized folder 410. Business logic found on the host computer(s) of web site 10 could choose to present the first special offer 530 based upon the fact that user is currently considering a similar item, such as Product 1 532. The logic could even be more advanced, such as presenting the offer 530 only if the user selected Product 1 before the sale price was effective on Product 3. Since the user might have been more interested in Product 3 had it been on sale when Product 1 was selected for the site-within-a-site feature 400, the web site logic presents this offer on the category overview page 520.

Special offer 534 concerns Product 1 532, a product already found in the personalized folder of the user. In this case, the business logic may have determined that the user has been reviewing Product 1 and Product 2 for a predetermined time (such as one week) or for a predetermined number of visits (such as three visits). In such circumstances, the web site 10 could be pre-configured to offer the user a special discount on one of the items if the product were purchased today (or some other time period, visit count, or relevant criteria).

This second embodiment of the category overview page 520 can be configured to let the user know if a new item has been added to a relevant subcategory 140 since the user last browsed that area of the product hierarchy 100. This is done through notification 536. Alternatively, rather than comparing the addition of an item 12 to the last browsing of the product hierarchy 100, the notification could be based upon the last relevant use of the shopping assistant service 200. As described above, one embodiment of the shopping assistant service 200 allows the user to specify features of a product that are desired. After the features are specified, the shopping assistant service 200 presents the user with a list of products that meets those criteria. The notification 536 could thus inform the user that a new product has been added to the web site 10 that meets the criteria specified in the last use of the shopping assistant service 200. To accomplish this, it would simply be necessary to store the date and specifics of the last shopping assistant usage by the user in the user's personalized folder 410. If the user had used the shopping assistant for multiple types of products, each of those uses could be stored in the relevant area of the user's personalized folder 410. The web site 10 could then operate the shopping assistant on only those items 12 added to the system since the last usage. If any items 12 were returned by the shopping assistant, a notification 536 could be presented in the category overview page 520.

It is also possible to present users with a link 538 that allows the user to specify the importance of various product attributes maintained by the web site 10. For instance, in the category of Small TVs, the users may specify that the presence of a comb filter, a sleep/alarm timer, and screen size are the most important attributes; and that the presence of picture-in-picture capability and A/V jacks were completely unimportant. This information could be stored in the personalized folder 410 of the user, and could be used to determine the presence and sort order of the product attributes shown to the user in product detail pages 480 and product comparison pages 500.

Although an illustrative version of the invention has been described above, it should be clear that many modifications to the site-within-a-site feature 400 may be made without departing from the scope of the invention. For example, although the preferred embodiment of the present invention is described in the context of a web site offering retail shopping, other applications of the described invention are clearly available. For instance, the site-within-a-site feature 400 could be used on a financial investment site. In such a site, the investment opportunities could be categorized into stocks, bonds, and mutual funds. The mutual funds could be divided into growth and value funds. Growth funds could then be divided into large cap funds, mid cap funds, and small cap funds. Fund attributes could include return on investments, loads, and social investment strategies. By using a site-within-a-site feature 400 in this context, a purchaser could store investment opportunities for later review. New funds that meet the user's criteria could be suggested in the site-within-a-site category overview page.

Another alternative embodiment of the present invention would be the inclusion of links to the product hierarchy 100 within the site-within-a-site feature 400. One of the clear benefits of the present invention is that the user can view product detail and comparison pages 480, 500 relating to the suggested products without leaving the site-within-a-site feature 400. Thus, if links to the general product hierarchy 100 are made available with the site-within-a-site feature 400, it would be imperative to make it clear to the user that they have left the site-within-a-site feature 400 when one of those links is followed. This is easily accomplished with the presence of the identification banner 450 on all site-within-a-site pages.

Finally, although the web site 10 was shown with each category 130 having subcategories 140, it is well within the scope of the present invention to populate a category 130 directly with items 12 without the use of subcategories 140. In this case, those pages that list categories 130 and subcategories 140 will simply list the categories 130. In some cases, it may be useful to assume that each category 130 that is directly populated with items 12 has instead only a single subcategory 140 entitled “see products” or some similar term.

What is claimed is:

1.A feature on a web site that presents items for customer evaluation in an item hierarchy having categories, the feature comprising:
a) a personalized folder in which users can store items for further consideration; and
b) a category overview page that automatically categorizes the items placed into the personalized folder utilizing some of the categories used in the item hierarchy, the category overview page then displaying the items in the personalized folder according to the categories used in the categorization.

2. The feature of claim 1, wherein the categories are divided into major categories and remaining categories.

3. The feature of claim 2, further comprising a major category page that lists only the major categories that contain items stored in the personalized folder.

4. The feature of claim 3, wherein the remaining categories are further divided into minor categories and subcategories.

5. The feature of claim 4, wherein the major category page lists the major categories and minor categories that contain items that have been placed in the personalized folder.

6. The feature of claim 5, further comprising:
a separate category overview page for each minor category listed in the major category page;
wherein each category overview page lists only those items categorized in the minor category associated with that category overview page; and
further wherein the major category page contains links to each of the separate category overview pages.

7. The feature of claim 6, wherein each category overview page lists by subcategory all the items placed in the personalized folder that are categorized in the minor category appropriate for that category overview page.

8. The feature of claim 7, wherein each item listed in each category overview page contains a link to an item detail page containing detailed information about that item, and wherein each item detail page contains a link directly to the category overview page for the minor category of the item, and a link to the major category page.

9. The feature of claim 8, wherein the presence of multiple items within the same subcategory causes of the personalized folder a link to at least one of the other items in the same subcategory to appear on the item detail page for the items in that subcategory.

10. The feature of claim 9, further comprising comparison pages that contain comparisons of a subset of those items within the same subcategory.

11. The feature of claim 10, wherein the subset can vary from one item to all items in the subcategory, and further wherein the user can select the items in the subcategory to include in the subset.

12. The feature of claim 9, wherein the category overview page, the major category page, the item detail page, and the comparison page all contain a visual indication that the user is within the feature of the web site.

13. The feature of claim 1, wherein the category overview page contains specific information about the category relevant to the category overview page, further wherein the specific information is chosen from the set including: a frequently asked questions list, a glossary of relevant terms, and reliability data.

14. The feature of claim 4, further comprising an offer of a discount on a promoted item that is not in the personalized folder, where the promoted item is categorized in at least one of the subcategories listed on the category overview page.

15. The feature of claim 1, further comprising an offer on the category overview page to discount one of the items listed on one of the category overview pages.

16. The feature of claim 15, wherein the offer to discount one of the listed items is presented only after the item has been listed on the category overview page for a preset period of time.

17. The feature of claim 15, wherein the offer to discount one of the listed items is presented only after the item has been listed on the category overview page for a preset number of visits by the user.

18. The feature of claim 12, further comprising a shopping assistant that presents items to the user based upon item attribute criteria selected by the user.

19. The feature of claim 18, further comprising a notification on the category overview page of a newly added item that matches the item attribute criteria previously used by the user to select items for the personalized folder using the shopping assistant.

20. The feature of claim 1, further comprising a mechanism accessible from the category overview page that allows a user to specify the importance of various item attributes for items listed on the category overview page.

21. The feature of claim 4, wherein some categories contain only a single subcategory.

22. The feature of claim 1, wherein the item constitutes a product offered for sale through the web site.

23. The feature of claim 1, wherein the item constitutes an investment opportunity.

24. The feature of claim 1, wherein the item constitutes a service offered through the web site.

25. A web site that presents items for customer evaluation comprising:
a) a product hierarchy containing multiple items available on the web, the product hierarchy having
i) categories and subcategories into which the items are categorized, and
ii) an item detail page containing detailed information about a single item; and
b) a site-within-a-site feature having the ability to store site-within-a-site items that have been selectively added to the site-within-a-site feature by the user for later consideration, the site-within-a-site feature having
i) a main site-within-a-site page listing the site-within-a-site items, and
ii) a site-within-a-site product detail page containing detailed information about a single site-within-a-site item, a link to the main site-within-a-site page, and at least one link to a second site-within-a-site product detail page for site-within-a-site item.

26. The web site of claim 25, wherein the product hierarchy further comprises an item comparison page that compares items within the same subcategory, wherein the items to be compared are selected by the user.

27. The web site of claim 26, wherein the site-within-a-site feature further comprises a site-within-a-site comparison page that compares site-within-a-site items, wherein the items to be compared are selected by the user, and wherein the site-within-a-site comparison page contains a link to the site-within-a-site product detail page of each site-within-a-site item compared.

28. The web site of claim 27, wherein the site-within-a-site feature further contains categories and subcategories into which site-within-a-site items are automatically categorized when they are added to the feature.

29. The web site of claim 28, wherein the links within the site-within-a-site detail pages to other site-within-a-site detail pages exist only for detail pages related to items in the same subcategory.

30. The web site of claim 28, wherein the site-within-a-site comparison page compares only items that are categorized within the same subcategory.

31. The web site of claim 28, wherein the main site-within-a-site page lists only the categories that contain site-within-a-site items, and further comprising a category overview page that lists the site-within-a-site items within each category.

32. The web site of claim 31, wherein the category overview page contains specific information about the category relevant to the category overview page, further wherein the specific information is chosen from the set including: a frequently asked questions list, a glossary of relevant terms, and reliability data.

33. The web site of claim 31, further comprising an offer of a discount on a promoted item that is not a site-within-a-site item, where the promoted item is categorized in the same subcategory of at least one of the site-within-a-site items on the category overview page.

34. The web site of claim 31, further comprising an offer on the category overview page to discount one of the site-within-a-site items listed on the category overview pages.

35. The web site of claim 34, wherein the offer to discount one of the site-within-a-site items is presented only after the site-within-a-site item has been listed on the category overview page for a preset period of time.

36. The web site of claim 34, wherein the offer to discount one of the site-within-a-site items is presented only after the site-within-a-site item has been listed on the category overview page for a preset number of visits by the user.

37. The web site of claim 25, wherein the web site further comprises a shopping assistant that presents items to the user based upon item attribute criteria selected by the user.

38. The web site of claim 37, further comprising a notification on the category overview page of a newly added item that matches the item attribute criteria previously used by the user to select site-within-a-site items using the shopping assistant.

39. A web site for selling items to users comprising:
a) a hierarchical categorization scheme for organizing all of the items available on the web site;
b) an item hierarchy navigational tree for accessing item information using the hierarchical categorization scheme, said navigational tree having as its ultimate root a home page, and said navigational tree having as its leaf nodes item detail pages which contains information about a single item;
c) personalized storage means, unique to a user name, for storing item sections from a user;
d) an automatic categorization mechanism for automatically categorizing the user item selections according to the hierarchical categorization scheme;
e) a second navigational tree for accessing item information for the user item selections, the second navigational tree also using the hierarchical categorization scheme with the home page as its ultimate root, and containing only item detail pages for the user item selections as its leaf nodes, with said second tree and said first tree having no leaf nodes in common, wherein the second navigational tree is expanded and pruned as the user adds and removes item selections from the personalized storage means.

40. The web site of claim 39, wherein at least one of the item detail pages of the second navigational tree contains a link directly to another item detail page of the second navigational tree.
